(19) United States
(12) Patent Application Publication
(10) Pub. No.: US 2009/0257077 A1
(43) Pub. Date: Oct. 15, 2009

(54) DEFECT AVOIDANCE IN DIGITAL PRINTING

(75) Inventor: Kristine A. German, Webster, NY (US)

Correspondence Address: FAY SHARPE / XEROX - ROCHESTER, 1228 EUCLID AVENUE, 5TH FLOOR, THE HALLE BUILDING, CLEVELAND, OH, 44115, US

(73) Assignee: Xerox Corporation, Norwalk, CT (US)

(21) Appl. No.: 12/103,131

(22) Filed: Apr. 15, 2008

(51) Int. Cl. G06K 15/00; G06F 15/00

(52) U.S. Cl. 358/1.14; 358/3.26

(57) ABSTRACT

A method of digital printing in which, upon sensing a defect area in a page image in the marking process or on the printed media, the page image is reconfigured to rotate, translate, change print jobs, or reduce the number of pages printed concurrently to avoid the defect area and continue the printing process without interruption utilizing the available non-defect area.

### BACKGROUND

The present disclosure relates to digital printing of images such as by electrostatic or ink jet marking on print media either in roll or sheet form. Such print engines have found widespread usage and popularity in view of their relatively high productivity for small and medium size print jobs and particularly for print jobs where time is of the essence and a high rate of productivity is required.

However, where defects arise in the printing process, the run time of the printing system must be interrupted in order to repair or replace machine components responsible for the defect, thereby resulting in reduced productivity. For example, clogged or inoperative ink jets may cause streaks or voids in the image marking, or a gouge or defect in a photoreceptor in an electrostatic print engine may produce periodically recurring blotches in a limited area of the image being marked on the print media, with the balance of the marking remaining of acceptable quality.

It has thus been desired to provide a way or means of avoiding a defective area of the image in the marking process yet be able to continue the printing operation thereby avoiding a shutdown of the printing process and the resulting loss of productivity.

### SUMMARY

The present disclosure provides a technique for continuing printing from digital images either electrostatically or by direct marking such as with the use of ink jets in the event a predictable defect, such as a continuous or periodically recurring defect, is detected in the marking process and particularly where the cause of the defect is isolated to a localized area of the marking process. The present disclosure describes a way and means for relocating or shifting the image within the marking process or on the print media to enable continuation of the printing process without interruption or the necessity of shutting down the print engine for maintenance or repair.

The print engine controller's model is altered so as to reroute and/or reschedule pages and/or jobs such that the subsequently printed pages have acceptable quality despite the marking system's reduced capability due to the defect. The disclosure has particular applicability to wide format printing such as 2-up continuous feed processes and provides for continuing concurrent printing of more than one print job to minimize productivity losses. In particular, the technique or method of the present disclosure permits translational shifting of images and rotation of images to avoid localized defects in the marking process yet enable continued printing of images in the non-defect area without repairing the printing process.

### BRIEF DESCRIPTION OF THE DRAWINGS

FIG. 1 is a pictorial representation of a digital image marking engine employing print media in roll form;

FIG. 2 is a view similar to FIG. 1 of a marking engine employing sheet feed print media;

FIG. 3A is a pictorial representation of wide page image or landscape format media printing showing a defect area;

FIG. 3B is a view similar to FIG. 3A with the page image rotated for narrow edge or portrait format feed printing to avoid the defect area;

FIG. 4A is a pictorial representation of 2-up side-by-side page image printing with a defect area;

FIG. 4B is a view similar to FIG. 4A, showing the page images translated to avoid the defect area;

FIG. 5A is a pictorial representation of 2-up side-by-side page image printing with another defect area;

FIG. 5B is a view similar to FIG. 5A, showing a single page image rotated to utilize wide page image feed to avoid the defect area; and,

FIGS. 6A and 6B comprise a block flow diagram of the process of the present disclosure.

### DETAILED DESCRIPTION

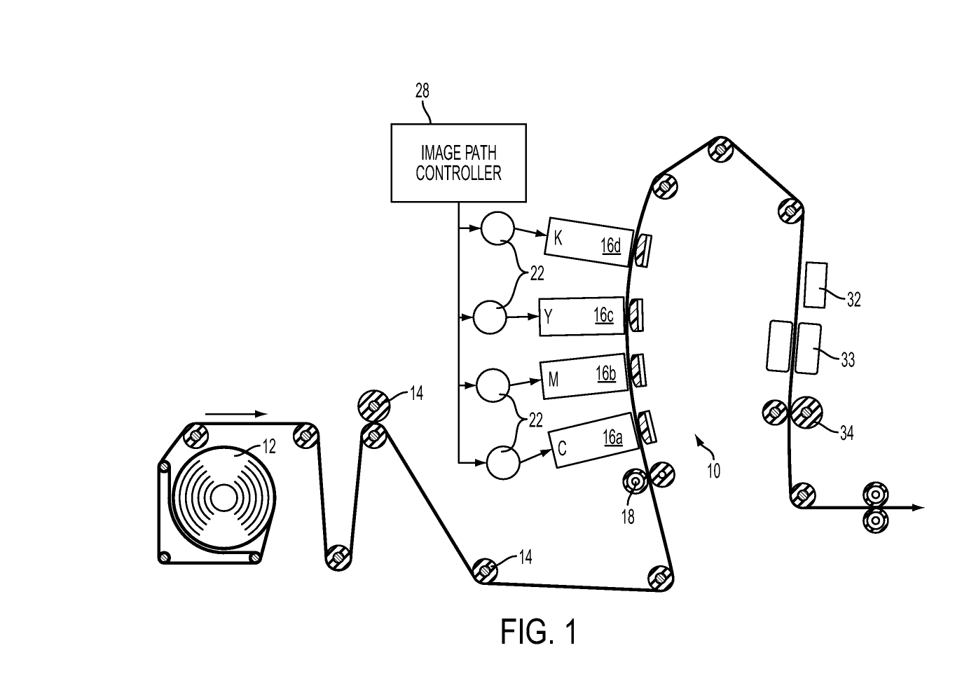

Referring to FIG. 1, a marking engine is indicated generally at 10 and includes paper media 12 in roll form feeding through rollers 14, 18 to print heads 16a, 16b, 16c, 16d which may be of the ink jet variety and which are controlled by an image path controller 28 inputting signals to print controllers 22 for each of the print heads 16a-16d. The media, after marking by the print heads, is passed by a sensor 32 for detection of defects in the printed image. The inked image may then be reheated by mid-heaters 33 in preparation for final passage through a final gloss and spread roller unit 34. The printed media is then transported for further handling in finishing stations (not shown).

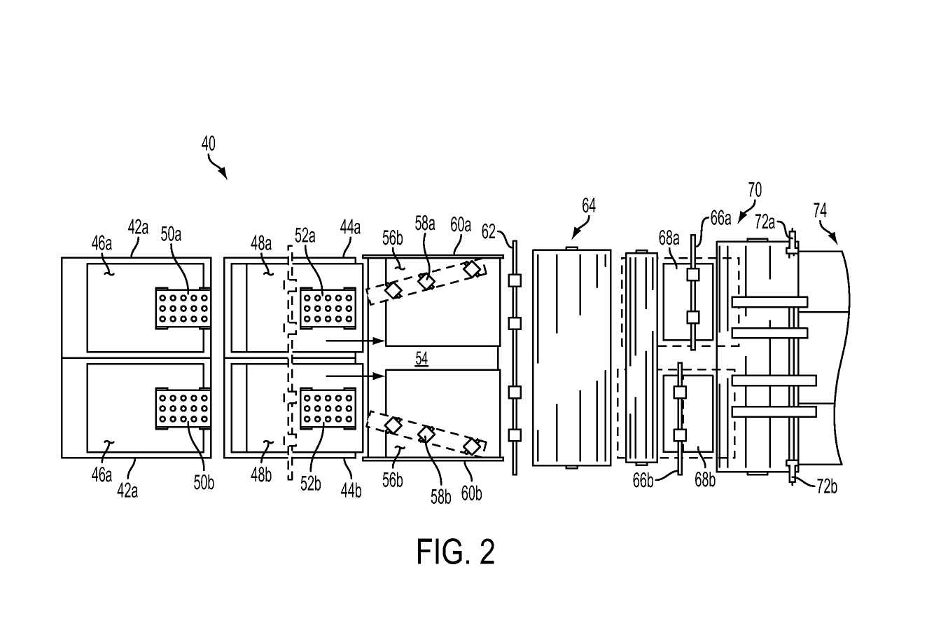

Referring to FIG. 2, another type of print engine is indicated generally at 40 which includes a plurality of side-by-side sheet stackers 42a, 42b and 44A, 44B which contain respectively cut sheet media denoted respectively 46a, 46b and 48a, 48b. The stackers or trays include feeders/separators respectively 50a, 50b and 52a, 52b which are operative for feeding individual sheets from adjacent trays concurrently along path 54 in the direction denoted by the black arrows to the positions indicated at 56a, 56b for guidance by edge registration system 58a, 58b and lateral side registration edges 60a, 60b. The sheets are advanced through roller 62 to an imaging system indicated generally at 64 which may comprise a photoreceptor drum or belt for marking or printing. After marking, the sheets are moved by feed rollers 66a, 66b respectively from their position indicated at 68a, 68b to a lateral merging system indicated generally at 40 through a lateral side shifting system 72a, 72b to a stacking system indicated generally at 74. As is common in the industry, but not shown in FIG. 2, various feeding trays, stacking trays, and media handling hardware are available beneath the shown cross section to provide for the selection and transport of media cut to various dimensions.

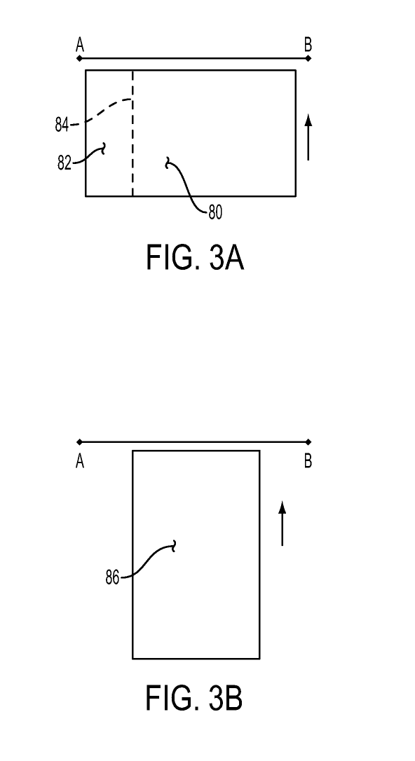

Referring to FIGS. 3A and 3B, the width of the printing process is represented by the horizontal line denoted by the reference characters A-B. In FIG. 3A, a page image is arranged to be printed in wide or landscape format on media extending substantially the full width of the available printing process on a wide sheet format denoted by reference numeral 80 in solid outline. An area of defect in the process is denoted by reference numeral 82 and is located on the page image 80 in the region between the vertically oriented dashed line and the left hand margin of the sheet 80, leaving the portion of the page between the dashed line 84 and the right hand edge of the page image 80 unaffected by the defect and usable for continued printing or marking.

Referring to FIG. 3B, the page image has been rotated 90° to orient the narrow edge of the page in the feed or process direction, indicated by the black arrow such, that the width of the page is located in the non-defect region to the right of the defect area 84, thereby enabling continued printing of the new page image 86 in the portrait format on the media.

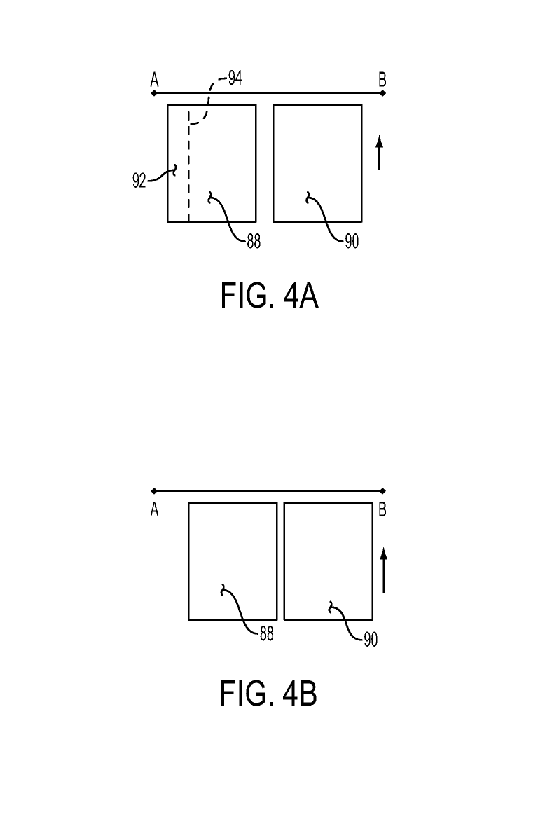

Referring to FIGS. 4A and 4B, a printing process for printing 2-up images as denoted by reference numerals 88, 90 is shown where a defect area 92 is located between the dashed line 94 and the left-hand margin of the page 88. In response to this defect location, the system has shifted the printing of the page images 88, 90 to the right. The right-hand margin of the image 90 remains within the boundaries of the process width A-B, whereas the image 88 has been shifted in a rightward direction by the width of the process defect 92 consequently reducing the space between the images 88, 90 yet allowing continued printing of the 2-up printing process.

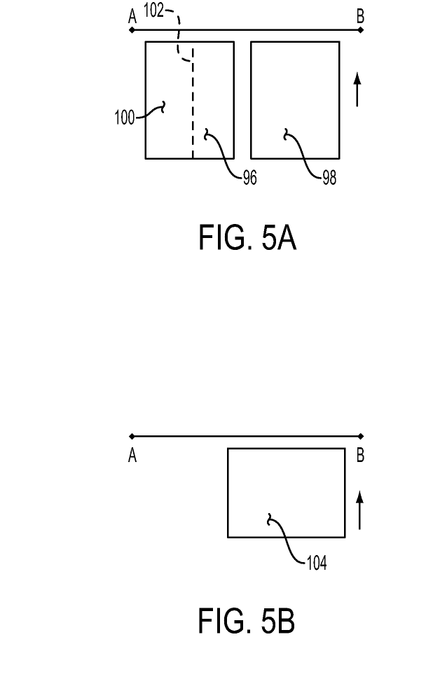

Referring to FIGS. 5A and 5B, a 2-up page printing is illustrated in FIG. 5A wherein pages 96, 98 are being printed side-by-side in the process direction indicated by the black arrow with the available process printing width indicated by the horizontal line A-B. In the process of FIG. 5A, an image defect area 100 is present between the dashed line 102 and the left margin on the page 96. Referring to FIG. 5B, a page image 104 is being printed in landscape format in the region to the right of the defect area 100 of the process width A-B which is free of defect thereby enabling continued printing or marking of a single page serially without interruption of the printing process. Thus, by rotating a page image 90° the non-defect area of the printing process is continued to be utilized albeit with a single page without the necessity of stopping printing in order to repair or replace machine components responsible for the defect in the process. If appropriate, page image 104 may be chosen from a different print job.

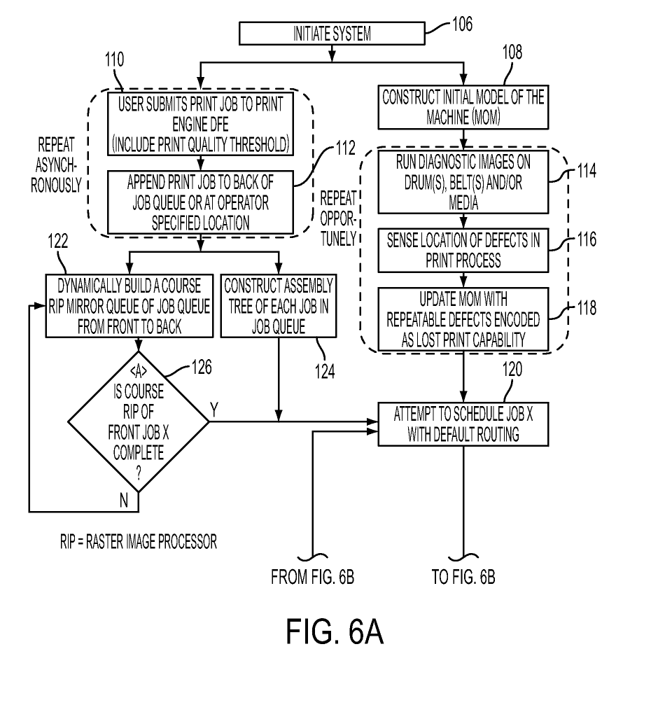

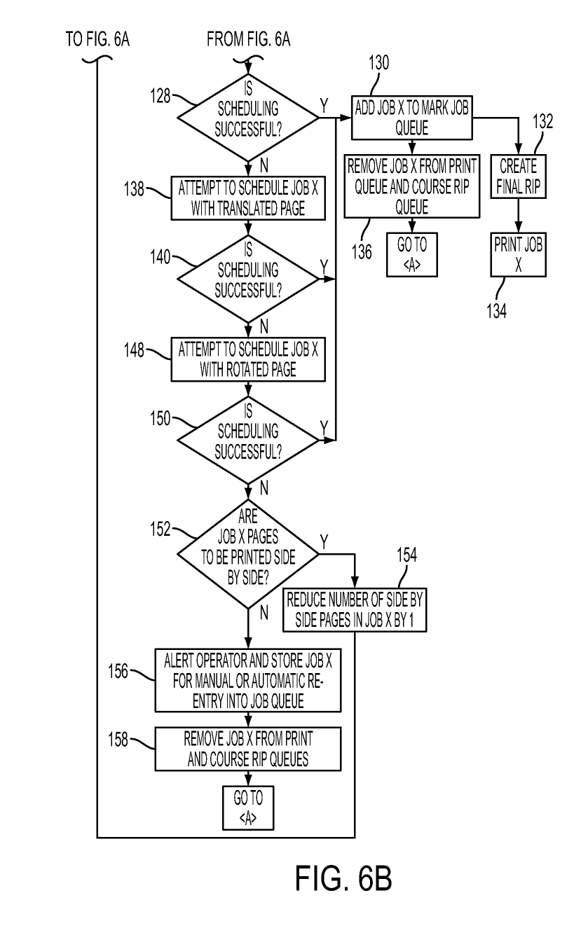

Referring to FIGS. 6A and 6B, a flow diagram of the process of the present disclosure is shown beginning at step 106 and proceeds concurrently therefrom to construct an initial software model of the machine at step 108 and to receive a user submitted print job to the digital front end (DFE) of the print engine at step 110. The system proceeds from step 110 to attach the print job to a job queue or at a user specified location at step 112; and, steps 110, 112 may be repeated asynchronously.

The system proceeds from step 108 to run diagnostic images on the in-process stations and the media at step 114 and proceeds to sense and analyze the location of defects in the process at step 116. The system then proceeds to update the software model of the machine at step 118 and coding predictable defects as lost print capability. Defects are predictable if they are either continuous or periodic with respect to one or more marking elements in the print process. For the purpose of the present invention, defects can be either voids (i.e. the lost ability to produce pixel markings on demand) or extraneous marks (i.e. the production of marks regardless of demand). The steps 114-118 are repeated opportunely.

The system then proceeds to step 120 and tries to schedule a given job X with default routing.

From step 112, the system proceeds to concurrently perform a coarse raster image process mirror queue of the job queue from front to back at step 122 and also constructs an assembly tree of each job in the job queue at step 124 and then proceeds to step 120.

From step 122, the system proceeds to ask whether the coarse rip of the front job X is complete at step 126; and, if the determination at step 126 is answered in the affirmative, the system proceeds from there to step 120. However, if the query at step 126 is answered in the negative, the system returns to step 122.

The system proceeds from step 120 to step 128 and asks whether the scheduling is successful. The job can only be successfully scheduled if all job requirements are within the capabilities of the machine as encoded in the model of the machine. A job will not be successfully scheduled if the job requires printed marks in a location where the printing process produces a void defect, or the job requires an unmarked region where the printing process produces extraneous mark defects. For example, if the coarse RIP of a job specifies that magenta pixels are required in a page region where the machine indicates that the marking process is producing a predictable magenta void, the job requirements are not compatible with the machine capabilities, and the job cannot be successfully scheduled. However, if the coarse RIP of a job indicates there is no demand for magenta in page region that is producing a magenta void, the job requirements and the machine capabilities are compatible in this regard, and such a magenta void does not preclude scheduling of the job. With respect to extraneous mark defects, a job will not be scheduled if the coarse RIP indicates a demand for a mark free region for a given color separation where the machine specifies that the process has lost the capability of producing a mark free region for that color. In the event that defective prints are acceptable as a final product for specific jobs, an operator would have the option to manually flag such jobs as being compatible with lost print capability associated with predictable void defects or extraneous mark defects, and such lost capability would not preclude scheduling of the flagged jobs. If the determination at step 128 is affirmative, the system proceeds to step 130 and adds job X to mark the job queue and proceeds concurrently to step 132 to create a final raster image process and to step 136 to remove job X from the print queue and coarse RIP queue. From step 132 the system proceeds to step 134 and print jobs X. From step 136 the system returns to step 126.

If the determination at step 128 is negative, the system proceeds to step 138 and attempts to schedule job X with a translated page and from there to step 140 and enquires as to whether the scheduling is successful. If the determination at step 140 is affirmative, the system proceeds to step 130; however, if the determination at step 140 is negative, the system proceeds to step 148, attempts to schedule job X with a rotated page, where the rotated page can also be translated from a default location as necessary. The system then proceeds to step 150 and enquires as to whether the scheduling is successful. If the determination at step 150 is affirmative, the system proceeds to step 130; however, if the determination at step 150 is negative, the system proceeds to step 152 and enquires whether there are job X pages to be printed side-by-side. If the determination at step 152 is answered in the affirmative, the system proceeds to step 154 and reduces the number of side-by-side pages in job X by one and then proceeds to step 120. The resulting side-by-side or one-at-a-time printed pages may be rotated or translated from a default location and orientation to optimize productivity of the remaining capability of the machine. However, if the determination at step 152 is negative, the system alerts the operator and stores job X for manual or automatic re-entry into the job queue at step 156 and then proceeds to step 158 and removes job X from the print and coarse rip queues and then returns to step 126.

The present disclosure thus provides for determining if defects exist in the marking process in digital printing and performs either translation and/or rotation of the pages, if possible, to proceed with printing or marking without interruption in the non-defect area of the printing width, thereby enabling optimization of productivity in a modified printing scheme, albeit with reduced capability until it is convenient to stop the process in order to repair or replace machine components responsible for the defect.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method of digital printing comprising:
(a) providing a print/marker engine and scheduling printing of plural page images on print media;
(b) disposing an image defect sensor with the print/marker engine and outputting a fault signal upon sensing a defect; and,
(c) rescheduling printing of the page image and avoiding the location of the sensed defect and continuing without interruption to print a page image free of the sensed defect.

2. The method defined in claim 1, wherein the step of continuing to print includes scheduling page images from different print jobs.

3. The method defined in claim 1, wherein the step of providing a print engine includes providing a print engine having at least one piezoelectric ink-jet print/marker head.

4. The method defined in claim 1, wherein the step of rescheduling includes scheduling printing a first selected type of page images in the region without defects; and, continuing scheduling printing of a second selected type of page images in the region of sensed defects.

5. The method defined in claim 1, wherein the step of rescheduling includes the step of rotating the page image to present the shortest edge of the page image in the direction of the media transport.

6. The method defined in claim 1, wherein the step of providing a print/marker engine includes providing an array of ink dispensing jets.

7. The method defined in claim 1, wherein the step of rescheduling includes translating a page image to the non-defect area of the media sheet.

8. The method defined in claim 1, wherein the step of providing a print/marker engine includes providing an electrostatic marking engine having a photoreceptor; and, the step of disposing a sensor with the print/marker engine includes disposing a sensor adjacent the photoreceptor.

9. The method defined in claim 1, wherein the step of disposing a sensor includes disposing a sensor adjacent the print media.

10. The method defined in claim 1, wherein the step of rescheduling includes reducing one of plural page images locations originally scheduled to be printed side-by-side on the media.

11. The method defined in claim 1, wherein the step of rescheduling includes translating plural page images originally scheduled to be printed 2-up to increase the margin therebetween.

12. A method of digital printing comprising:
(a) providing a print/marker engine capable of printing on print media;
(b) providing a digital front end (DFE) and scheduling page images for printing by the print/marker engine;
(c) disposing a print quality sensor with the print/marker engine and determining the location of predictable defects in the print process and outputting a defect signal to the DFE; and,
(d) rescheduling in the DFE a page image to be printed using a non-defective region of the print process and continuing printing without stopping the print engine in order to repair or replace machine components responsible for the defect.

13. The method defined in claim 12, wherein the step of providing a print/marker engine includes providing an electrostatic copier/printer.

14. The method defined in claim 12, wherein the step of rescheduling includes rotating a page image with respect to the media sheet.

15. The method defined in claim 12, wherein the step of rescheduling includes translating a page image with respect to the media sheet.

16. The method defined in claim 12, wherein the step of providing a print/marker engine includes providing an electrostatic marking engine with a photoreceptor and, the step of disposing a sensor with the print/marker engine includes disposing a sensor adjacent the photoreceptor.
